(19) United States
(12) Patent Application Publication
(10) Pub. No.: US 2014/0209030 A1
(43) Pub. Date: Jul. 31, 2014

(54) High Capacity Milking Claw

(71) Applicants: Stanley A. Brown, Visalia, CA (US); Monte Linninger, Hanford, CA (US)

(72) Inventors: Stanley A. Brown, Visalia, CA (US); Monte Linninger, Hanford, CA (US)

(21) Appl. No.: 13/752,329

(22) Filed: Jan. 28, 2013

(51) Int. Cl. A01J 5/00

(52) U.S. Cl. CPC A01J 5/00
USPC 119/14.54

(57) ABSTRACT

An improved high capacity milking claw comprising a top section removably connected to a bottom section to define a chamber that receives milk. A pressure manifold/collecting assembly attaches to the top section to flow milk into the chamber and connects to a vacuum system that draws milk from an animal. A bolt extends through a mounting stem in the bottom section to clamp the two sections together. Milk exits the chamber through a downwardly angled outlet. A transition area at the entrance to the outlet includes a scoop that extends below the lower end of the bottom section to increase the transition area and facilitate flow of milk from the chamber to achieve and maintain a stable vacuum. The scoop has a scoop length extending to the mounting stem, which is offset from the centerline of the bottom section to increase the size of the scoop.

### CROSS-REFERENCE TO RELATED APPLICATIONS

This patent application is a continuation-in-part of U.S. Design patent application Ser. No. 29/412,327 filed Feb. 1, 2012, U.S. Design patent application Ser. No. 29/412,333 filed Feb. 1, 2012, and U.S. Design patent application Ser. No. 29/412,338 filed Feb. 1, 2012, which claim priority to U.S. Provisional Application No. 61/580,221.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The field of the present invention relates generally to apparatuses that are utilized in milking systems with vacuum supplying machines that are configured to draw milk from the teats of a cow or other milk-producing animal. In particular, the present invention relates to milking claws having a chamber that receives milk from flexible tubing which connect, via inflations, to the teats of an animal and an outlet that discharges milk to a milk collection system. Even more particularly, the present invention relates to such milk claws that are configured to more smoothly, safely and effectively draw milk from the teats of the animal and transfer milk to the milk collection system.

B. Background

Milking claws have been in existence for a very long time. The function of the milking claw is to be utilized as a collection device for milk to flow from four individual animal teats into the claw where the milk is collected and then exits via a single outlet where a hose transports the milk to a stainless steel milk line. As well known in the dairy industry, milking systems require the application of vacuum to the teats to produce milk from an animal, such as a cow or other milk producing animal. Vacuum originates from a vacuum source, such as a vacuum pump, and is transported into the milk line, up to the hose, into the milk claw and ending inside a liner that is attached to the animal's teat. Vacuum acts on the teat end to stretch and elongate the teat tissue. This action causes the teat sinus to open where milk is extracted from the animal's udder.

Persons knowledgeable in the dairy industry understand that stable vacuum is very important to effectively milking a cow. To assist in achieving the stable vacuum, a vacuum regulator is utilized in the vacuum system. The dairy industry has done a very good job of accomplishing vacuum stability as far as the that stability pertains to the milk line. However, achieving and maintaining a stable vacuum in the portion of the milking system from the milk line to the liner is well known to be a constant challenge. As milk flows from the liner into the milking claw it is common for the volume of milk produced from the cow to exceed the capacity of the milking claw. This causes the claw to flood, thereby isolating vacuum from the source. Once this happens, vacuum will drop in the liner. This drop in vacuum reduces the vacuum that is available to fully stretch and elongate the teat and, as a result, milking slows down. To avoid this scenario, it is known to be advantageous to have a sufficient enough volume in the milking claw to handle the amount of milk produced by the cow. However, there is a balance between having a large enough volume in the claw and not having too much weight associated with the milking claw or exceeding the vertical space available below the teats. The addition of weight has a pulling effect on the liners attached to the cow's teat. When too much weight is added the milking claw, the liners will slip in relation to the teat and, if sufficient, cause the liner to fall off. Therefore, a problem in the dairy industry is how to add enough volume to the milking claw without adding so much weight and height that results in the problems during the milking process. In addition, it is preferred that the milking claw be ergonomically configured so as to be comfortably held in one hand of a dairy worker so he or she can support the milking claw when placing the liners on the teats.

In general, the balance between ergonomics, size, height, weight, capacity and manufacturing costs have led the milking industry to utilize a round or at least a substantially round design. Most milking claws that are available on the market have achieved approximately 300 cc in volume capacity while not adversely effecting the other elements mentioned above. However, with the higher producing and faster milking systems, the capacity of these milking claws is not adequate to prevent the claw from flooding and causing vacuum instability described above.

The dairy industry desires to have a milking claw with at least 400 cc of volume capacity without harming the ergonomics of the milking claw or significantly adding size and weight to the milking claw. Although it would appear beneficial to simply add height to the round design to achieve the desired capacity, adding more height will typically result in the milking claw being so tall that it does not effectively fit under the animals udder before contacting the ground and adversely affecting the proper alignment of the liner onto the cow's teat.

Removal of milk from the milking claw by way of a single outlet also important to maintaining stable vacuum. Once milk is in the milking claw, it is important to have the milk removed therefrom without blocking the vacuum source. Typical milking claw outlets have an outlet diameter of between 9/16″ to ⅞″. It is obvious to persons skilled in the art that larger outlet diameters generally remove milk from the milking claw easier and without flooding due the larger area carrying the milk and vacuum. However, as also known, the configuration of the outlet can affect removal of milk from the milking claw. In general, prior art milking claws do not show any innovation in the outlet area of the milking claw.

Somewhere near the lowest part of the claw an outlet is provided that has the same diameter as the milk hose that connects to milking claw. Milk enters the milking claw and gravitates to the point of the milking claw where the outlet is placed. In an effort to ease the transition of milk leaving the milking claw at this point as well as vacuum entering at the same point it is important to have adequate capacity for this transition to take place without causing the milk to flood and isolate the vacuum source.

While attempts have been made to achieve the desired capacity for a milking claw while not significantly increasing the size and weight thereof have been made, overall these attempts have not been entirely successful. Likewise, while attempts have been made to improve the flow of milk from the milking claw so as to avoid flooding the chamber thereof, existing milking claws generally have not achieved the desired outflow characteristics. What is needed, therefore, is an improved milking claw that provides additional milk capacity without substantially having increased size and/or weight and which provides improved milk outflow therefrom so as to not flood the chamber of the milking claw. The improved milking claw should be configured so it can be utilized in commonly configured milking systems in place of existing milking claws to more effectively and efficiently produce milk from a cow or other animal.

### SUMMARY OF THE INVENTION

The milking claw of the present invention provides the benefits and solves the problems identified above. That is to say, the present invention is directed to a milking claw which is configured so as to have increased milk capacity without substantially greater size and weight relative to prior art milking claws and with a specially configured outlet area that allows milk to more effectively flow from the interior chamber of the milking claw to prevent flooding thereof and the various problems that are associated therewith. More specifically, the milking claw of the present invention is sized and configured with additional capacity but without the extra size and weight that would otherwise be associated with such increased capacity and which would cause the liners to slip from the teats of the animal being milked. The present milking claw maintains beneficial ergonomics so that it can be comfortably held in a person's hand. The milking claw of the present invention has an outlet which is sized and configured to facilitate the flow of milk from the interior chamber of the milking claw so as to achieve and maintain a stable vacuum.

In one embodiment of the present invention, the milking claw generally comprises a bottom section, a top section that clamps to the bottom section to form a milk collecting chamber therebetween, an outlet hydraulically connected to the milk collecting chamber, a pressure manifold/connecting assembly connected to an upper surface of the top section, a mounting stem extending upward from the bottom section towards the top section, a bolt extending through the mounting stem to connect to a connecting nut so as to clamp the top section to the bottom section and a transition area in the bottom section adjacent to the outlet that is sized and configured to improve the outflow characteristics of milk exiting the milk collecting chamber. The top section has a body portion with an upper end and a lower end, with the body portion defining the upper surface at the upper end thereof. The bottom section has a body portion with an upper end, a lower end, a front end, a back end and a plurality of sidewalls. The lower end of the top section is cooperatively sized and configured with the upper end of the bottom section such that the top section is received on the bottom section. The outlet is attached to or integral with the bottom section to flow milk from the milk collecting chamber. The outlet is angled downward from the bottom section an outlet angle of approximately five to twelve degrees relative to a plane through the upper end of the bottom section. The pressure manifold/connecting assembly has one or more pulse nozzles, one or more pressure connection conduits and the connecting nut. As well known in the art, the pressure manifold/connecting assembly is configured to flow milk into the milk collecting chamber and support the milking claw below the animal during milking operations. The transition area comprises a scoop having a scoop length sized and configured to increase the size of the transition area and pool the milk in the transition area to improve the outflow characteristics of milk exiting the milk collecting chamber. The milk collecting chamber is sized between approximately 350 cc to approximately 500 cc, which is provided by the generally rectangular V-shaped configuration of the bottom section that is achieved by having the sidewalls of the body portion of the bottom section angle generally inward from the top end to the lower end thereof. The scoop extends between a sidewall of the bottom section and the mounting stem, with the mounting stem being offset from the center line of the bottom section in the direction away from the front end of the bottom section towards the back end thereof. Preferably, the scoop length is longer than the diameter of the outlet. The top section has a height between its upper end and lower end of approximately 0.6 inches and 1.0 inches. Preferably, the outlet angle is greater than an outlet diameter of the outlet.

In another embodiment, the present invention sets forth a top section for a high capacity milking claw that comprises a body portion having an upper end and a lower end, with the body portion defining an upper surface at the upper end thereof. The lower end of the top section is cooperatively sized and configured with an upper end of a bottom section so as to engage the bottom section and define a milk collecting chamber between the top and bottom sections. A pressure manifold/connecting assembly is connected to the upper surface of the top section, with the pressure manifold/connecting assembly having one or more pulse nozzles, one or more pressure connection conduits and a connecting nut. As known in the art, the pressure manifold/connecting assembly is configured to flow milk into the milk collecting chamber of the milking claw. An aperture in the upper surface of the top section is aligned with a mounting stem in the bottom section so as to receive a bolt through the mounting stem that connects with the connecting nut to secure the pressure manifold/connecting assembly to the upper end of the body portion of the top section. The mounting stem has a center line which is in spaced apart relation to a center line of the bottom section an offset amount away from a front end of the bottom section towards a back end of the bottom section to provide space for the scoop described above. The top section has a height between the upper end and the lower end thereof between approximately 0.6 inches and 1.0 inches. Typically, the pressure manifold/connecting assembly has a hanger lug associated therewith that is used to support the milking claw during milking operations.

In another embodiment, the present invention sets forth a bottom section for a high capacity milking claw that comprises a body portion having an upper end, a lower end, a front end, a back end and a plurality of sidewalls substantially extending between the upper end and the lower end. The upper end of the body portion is cooperatively sized and configured with the lower end of a top section such that the top section is received on the bottom section to define a milk collecting chamber therebetween. The bottom section further comprises an outlet that is attached to or integral with the bottom section so as to be hydraulically connected to the milk collecting chamber to allow milk to flow from the milk collecting chamber. The outlet is angled downward from the bottom section an outlet angle, which is typically between about five and twelve degrees measured relative to a horizontal plane extending through the upper end of the bottom section. A mounting stem extends upward from the bottom end of the bottom section towards the top section, with the mounting stem being sized and configured to receive a bolt therethrough to connect to a connecting nut so as to clamp the top section to the bottom section. A transition area in the bottom section adjacent to the outlet comprises a scoop, having a scoop length, to improve the outflow characteristics of the milk exiting the milk collecting chamber. The sidewalls of the body portion of the bottom section angle generally inward from the top end to the lower end thereof to define a generally rectangular V-shaped configuration for the bottom section in order to provide a milk collecting chamber that is sized between approximately 350 cc to approximately 500 cc. The scoop extends between a sidewall of the bottom section and the mounting stem, which is offset from the center line of the bottom section. The center line of the mounting stem is in spaced apart relation to the center line of the bottom section an offset amount in a direction away from the front end of the bottom section towards the back end of the bottom section to increase the scoop length and provide additional area in the transition area for increased pooling of the milk at the entrance of the outlet.

Accordingly, the primary aspect of the present invention is to provide an improved milking claw that has the advantages discussed above and elsewhere in the present disclosure and which overcomes the various disadvantages and limitations associated with prior art milking claws.

It is an important aspect of the present invention to provide a high capacity milking claw that has a top section which is joined with a bottom section to define a milk collecting chamber therebetween, with the bottom section being specially configured to improve the outflow characteristics of the milk that exits the milk collecting chamber.

It is also an important aspect of the present invention to provide a high capacity milking claw that comprises a bottom section having an outlet that is disposed at a downward angle to improve the flow of milk from the milk collecting chamber that is defined between the bottom section and a top section which is joined to the bottom section.

It is also an important aspect of the present invention to provide a high capacity milking claw that has a bottom section which comprises an improved transition area at the entrance to an outlet that allows milk to pool in the transition area before exiting through the outlet so as to achieve and maintain a stable vacuum in the milk collecting chamber.

It is also an important aspect of the present invention to provide a high capacity milking claw that has a bottom section which includes a scoop in the transition area next to the entrance to the outlet that pools milk therein so as to improve the outflow characteristics of the milk exiting the milking claw through the outlet by achieving and maintaining a substantially stable vacuum in the milk collecting chamber of the milking claw.

Another important aspect of the present invention is to provide a high capacity milking claw having a bottom portion with sidewalls that angle generally inward from the top end to the lower end thereof to define a generally rectangular V-shaped configuration for the bottom section in order to provide a milk collecting chamber that is sized between approximately 350 cc to approximately 500 cc but is still able to fit below the animal during milking operations.

Yet another important aspect of the present invention is to separately provide a top section and a bottom section for use with a high capacity milking claw that each have improved design and function so as to improve the use of the milking claw during milking operations, particularly with regard to improving the outflow characteristics of the milk as it exits the milking claw.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a front elevation view of milking claw that is configured according to a first embodiment of the present invention;

FIG. 2 is a back elevation view of the milking claw of FIG. 1;

FIG. 3 is a right side elevation view of the milking claw of FIG. 1;

FIG. 4 is a left side elevation view of the milking claw of FIG. 1;

FIG. 5 is a top view of the milking claw of FIG. 1;

FIG. 6 is a bottom view of the milking claw of FIG. 1;

FIG. 7 is a right side elevation view of the milking claw of FIG. 1 with the top section separated from the bottom section to show the milk collecting chamber, the seal between the two sections and the bolt that connects the two sections together;

FIG. 8 is a cross-sectional right side elevation view of the bottom section of the milking claw of FIG. 1 to better illustrate the mounting stem offset from the center of the body of the bottom section and the downward angle of the outlet tube;

FIG. 9 is a top view of the milking claw bottom of FIG. 3 better showing the scoop portion of the outlet;

FIG. 10 is a top view of the top section of the milking claw of FIG. 1 shown without the pressure manifold, hanger and connecting nut thereof to better show the upper surface of the top section;

FIG. 11 is a bottom view of the top section of FIG. 10 to better show the opening of the milk inlets into the milk collecting chamber of the milking claw of FIG. 1;

FIG. 12 is a right side elevation view of the top section of FIG. 10;

FIG. 13 is a front elevation view of the top section of FIG. 10;

FIG. 14 is a top view of a second embodiment of the top section of the milking claw of the present invention showing an alternative placement for the milk inlets;

FIG. 15 is a right side elevation view of the top section of FIG. 14;

FIG. 16 is a top view of a third embodiment of the top section of the milking claw of the present invention showing an alternative placement for the milk inlets; and

FIG. 17 is a right side elevation view of the top section of FIG. 16.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of one or more preferred embodiments and, as such, disclose one or more different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the description and figures included herewith generally describe and show certain configurations and positions for the components of the milking claw of the preset invention, such as the milk inlet tubes and pulse nozzles, for the milking claw, those skilled in the art will readily appreciate that the present invention is not so limited. In addition, the size, configuration and position of the inlet tubes and pulse nozzles, as well as other components, can be modified and still accomplish the various goals and objectives of the present invention.

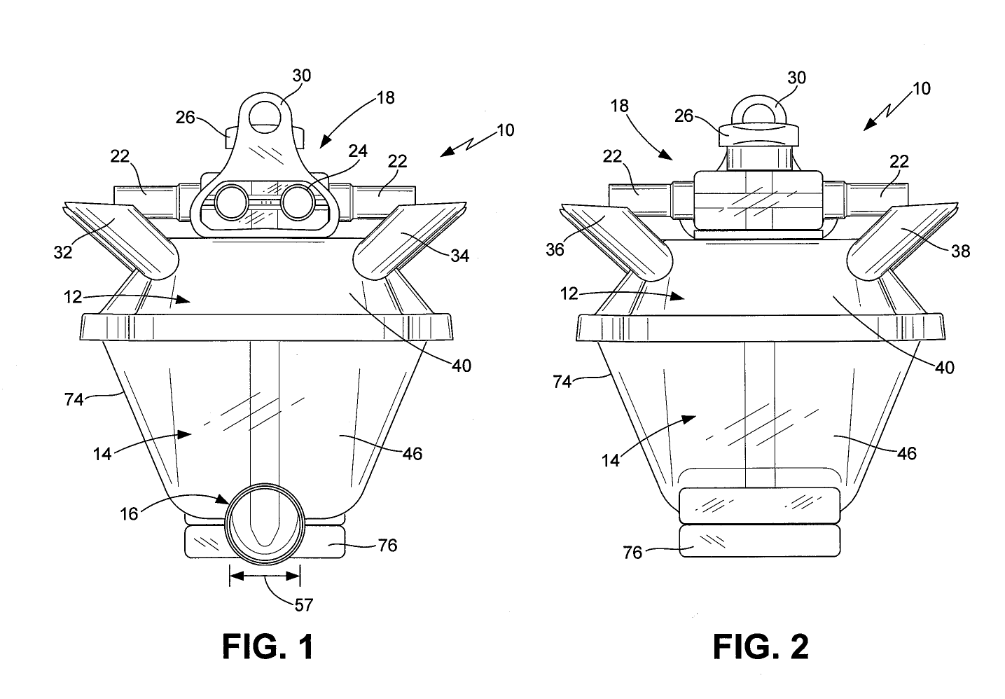

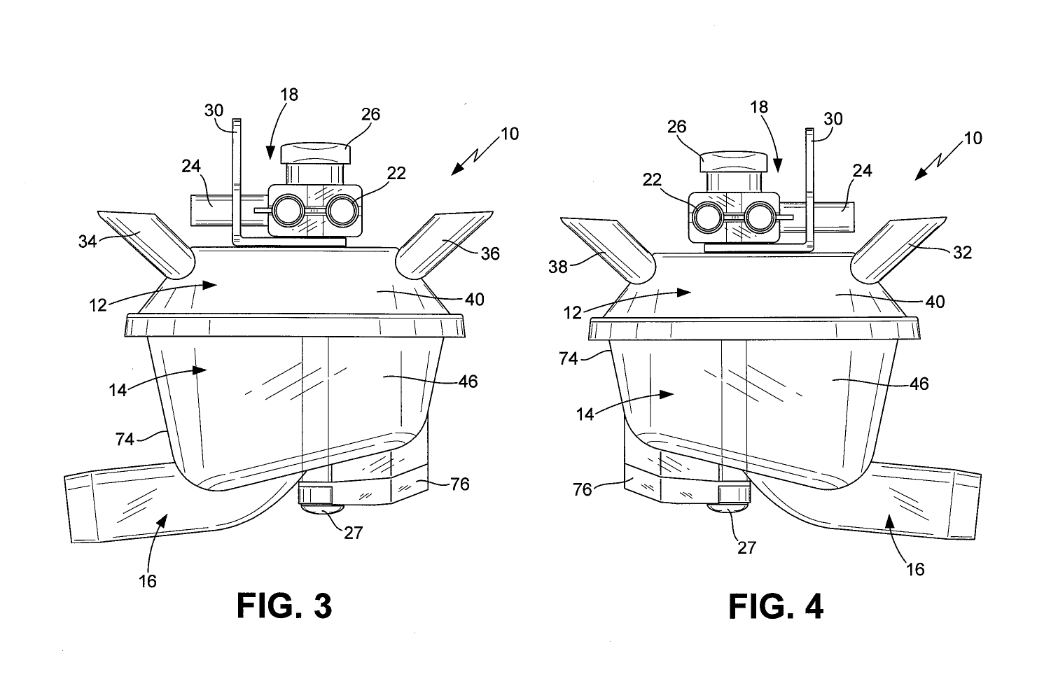

A milking claw that is configured pursuant to one embodiment of the present invention is shown generally as 10 in FIGS. 1 through 7. As well known in the art, milking claws such as the milking claw 10 of the present invention are utilized as part of a milking system that is arranged to obtain milk from the teats of an animal, such as a cow or the like. As with various prior art milking claws, the milking claw 10 is connected by way of flexible tubing to the inflations, having liners against the teats and shells around the liners, that attach to and engage the animal's teats. The inflations draw milk from the animal by applying vacuum to the animal's udders. As with prior art milking claws, the milking claw 10 receives milk from the inflations at various milk flow rates and passes the milk to a milk transport conduit. The milking claw 10 of the present invention, however, is much better at passing the milk to the milk transport conduit under a more stabilized continuous vacuum, which benefits the milking system. As set forth in more detail below, to achieve the desired increased capacity for the milking claw 10, without adding height that could interfere with use of the milking claw, requires moving away from the typical round design. The more rectangle configuration for the milking claw 10 of the present invention provides additional capacity in the corners of the generally rectangle configuration without detrimentally increasing the height. Although the rectangular configuration for milking claw 10 is likely to add to the costs for tooling and manufacturing the milking claw 10, relative to the prior art round designs, it provides the advantage of additional capacity inside the milk collecting chamber of the milking claw that prevents flooding and unstable vacuum, which reduces the problems with regard to the inflations slipping off of the teats described in the Background section. In addition, the milking claw 10 of the present invention substantially improves the outflow characteristics of the milk that further reduces the likelihood of flooding and unstable vacuum.

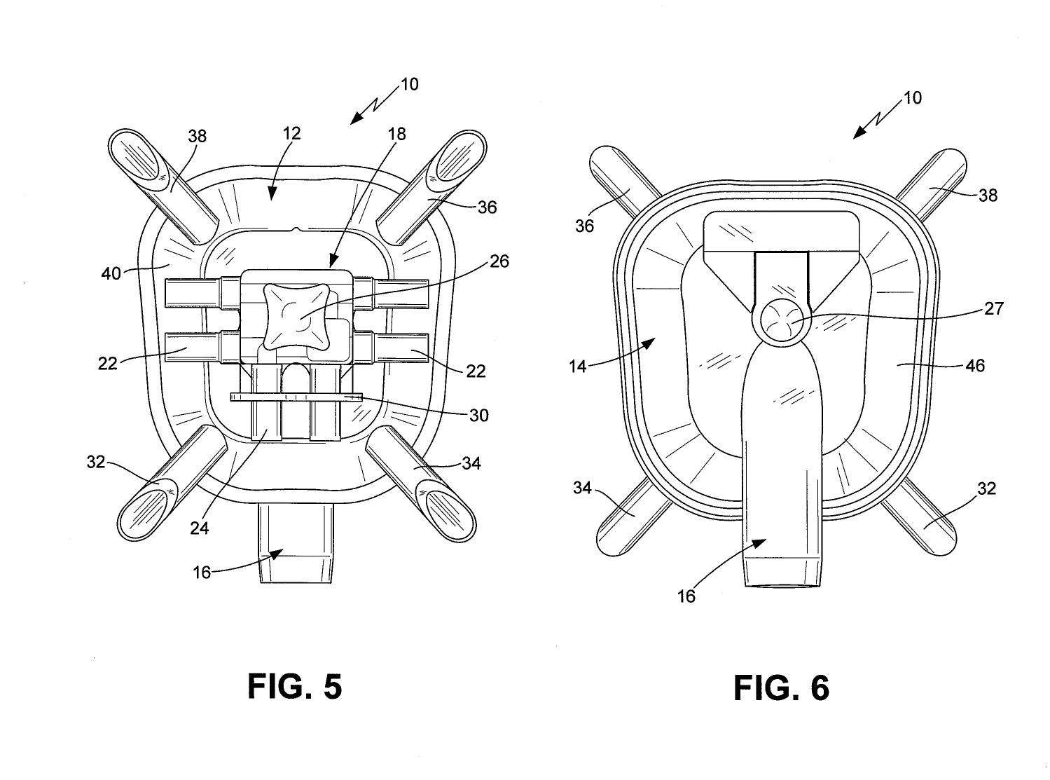

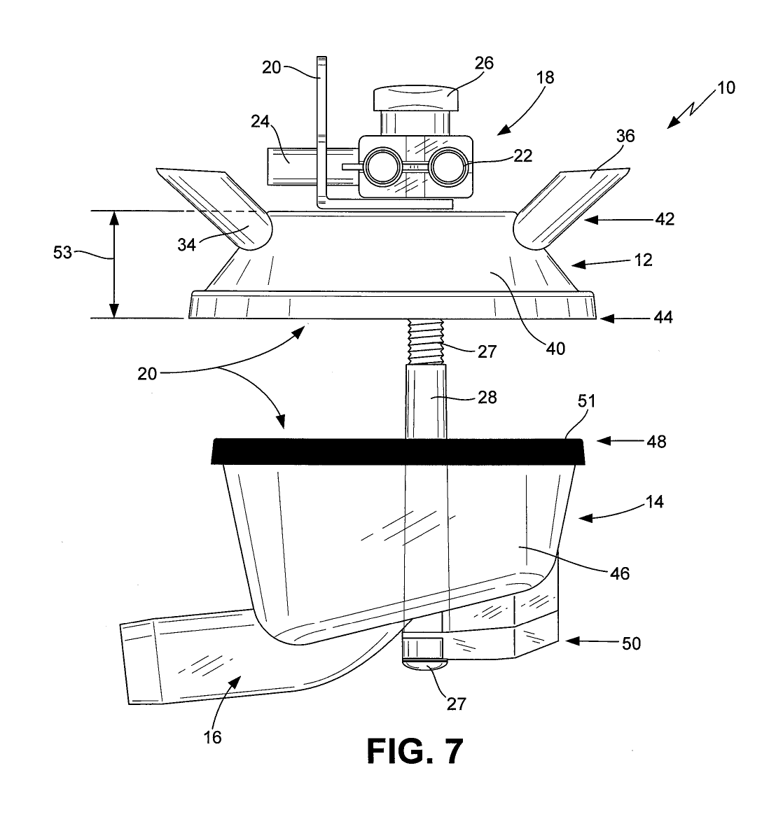

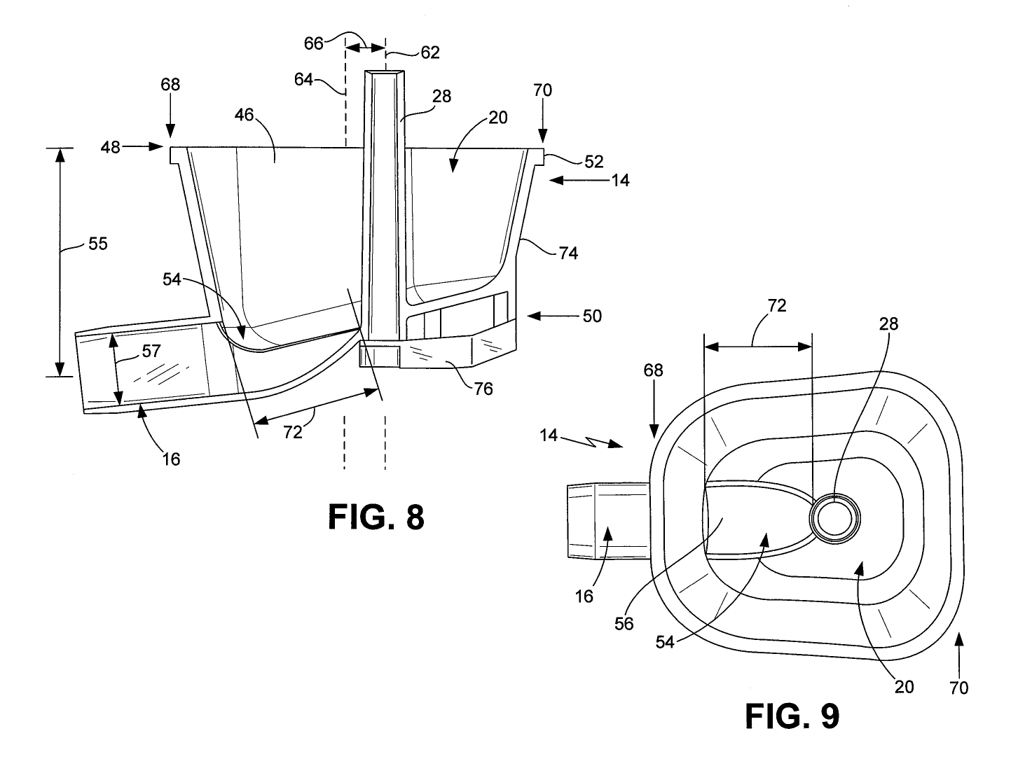

The milking claw 10 of the present invention is provided in a two-piece configuration generally comprising a top section 12, a bottom section 14, an outlet 16 associated with the bottom section 14 and a pressure manifold/connecting assembly 18 connected to the top section 12, as shown in FIGS. 1 through 7. The pressure manifold/connecting assembly 18 removably connects the top section 12 and bottom section 14 together to define a milk collecting chamber 20, best shown in FIG. 7, inside the milking claw 10 in which milk is received from the teats and from which it passes to the milk transport conduit. In the present configuration of milking claw 10, the assembly 18 is configured to securely clamp the top section 12 to the bottom section 14 and provide the various conduits necessary to draw milk from the teats by the inflations which are connected to the assembly 18. As such, the assembly 18 comprises a plurality, typically four, pulse nozzles 22 (best shown in FIG. 5), a pair of pressure connection conduits 24 (best shown in FIGS. 1 and 5) and a connecting nut or nut-like device 26 that connects to a bolt 27 which extends through a mounting stem 28 provided in bottom section 14, as best shown in FIGS. 7 and 8. The assembly 18 also includes a hanger lug 30 that typically extends generally upward from the top section 12 for suspending the milking claw 10 below the animal during milking operations. The configuration and use of the assembly 18, including the pulse nozzles 22, pressure connection conduits 24, connecting nut 26 and the bolt 27 are generally well known in the art.

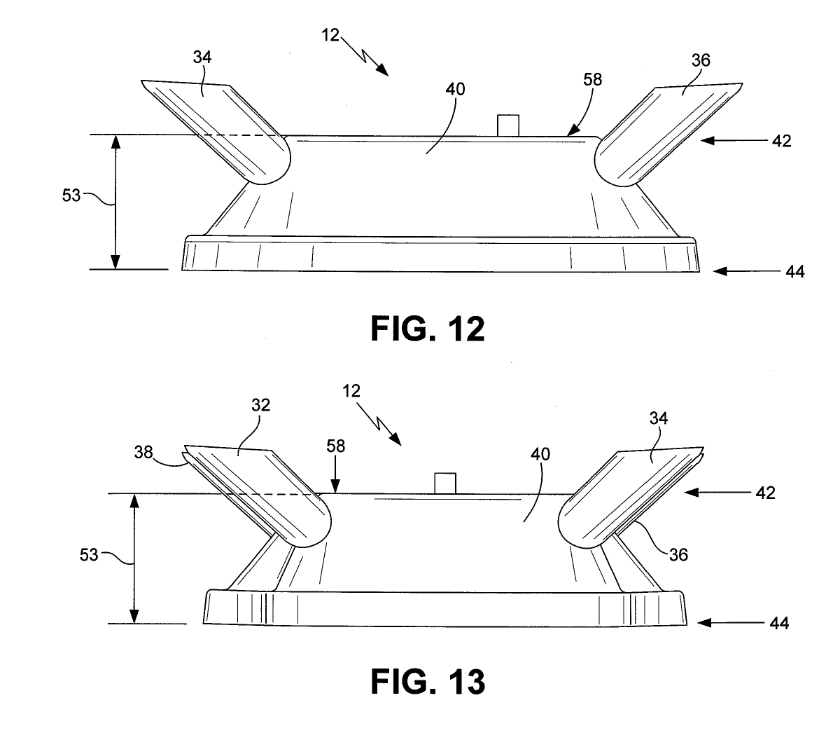

The top section 12 is an intricate part of achieving the functionality of the milking claw 10 as a whole. The top section 12 comprises the four milk inlets, shown as 32, 34, 36 and 38 in FIGS. 1-7 and 10-17, from the four milking quarters from the cow. As will be readily appreciated by those skilled in the art, the capacity of the milking chamber 20 is from the combined internal volume of both top section 12 and bottom section 14. As also can be readily appreciated by persons skilled in the art, it is desirable to have as much capacity for the milking chamber 20 as can be achieved without excessive weight for the milking claw 10. The top section 12 comprises a body portion 40 that has an upper end 42 and a lower end 44, as best shown in FIGS. 7, 12-13, 15 and 17. The bottom section 14 comprises a body portion 46 having an upper end 48 and a lower end 50, as best shown in FIGS. 7 and 8. The shape of top section 12 at the lower end 44 thereof where the top section 12 connects to the bottom section 14 needs to be substantially similar to the upper end 48 of the bottom section 14 such that these two sections 12/14 fit together in a manner that does not allow for leaks from the milk collecting chamber 20. In a preferred configuration, milking claw 10 includes the use of a flexible sealing member 51, which is typically positioned on a seal supporting surface 52 on bottom section 14, as shown in FIG. 8. The flexible sealing member is secured between the top section 12 and bottom section 14 when these two sections 12/14 are clamped together by the connecting nut 26 when it is threadably received on the bolt 27 extending upward from the lower end 50 of the bottom section 14. The height of top section 12 between the upper end 42 and lower end 44 thereof, which is shown as 53 in FIGS. 12 and 13, must not be too tall so as to minimize the overall height of the combined parts of milking claw 10. However, the top section 12 must be adequate in height, typically approximately 0.7 to 0.8 inches, to allow for the inlets 32, 34, 36 and 38 to be welded or molded onto top section 12. The top section 12 usually requires a height 53 of at least 0.6 inches but no more than 1.0 inch. Much lower than 0.6 inches of height 53 will typically not leave sufficient room from the milk inlets 32/34/36/38 and a height 53 greater than about 1.0 inch will typically be too tall to fit under the cow. As shown in FIGS. 1-7, 12-13, 15 and 17, the milk inlets 32/34/36/38 extend above the upper end 42 of top section 12. Each of the milk inlets 32-38, which are also commonly referred to as nozzles, connect to flexible housing that attach to the inflations which draw milk from the teats of the animal.

The milking claw 10 of the present invention also includes a transition area 54 that connects the interior milk collecting chamber 20 to the outlet 16. In an improvement over prior art milking claws, the milking claw 10 is provided with extra volume in the transition area 54 near where the outlet 16 hydraulically connects to the milk collecting chamber 20 defined by the combined top section 12 and bottom section 14. In addition to the extra volume in transition area 54, milking claw 10 of the present invention has a somewhat scoop configuration, shown as scoop 56, in the transition area 54, as best shown in FIGS. 8 and 9 and the outlet 16 is angled downwards. In a preferred configuration, the outlet 16 is angled downwards at an outlet angle 55, as shown in FIG. 8, between approximately five to twelve degrees in relation to a horizontal plane through the upper end 48 of the bottom section 14 of the milking claw 10, which also substantially corresponds to a horizontal plane through the lower end 50 of the bottom section 14. An outlet angel much less than about five degrees is not likely to drain well, whereas an angel much more than twelve degrees is likely to cause the hose to push the claw out of position when in use under the animal.

As will be readily appreciated by those skilled in the art with regards to milking claw 10 of the present invention, during milking operations the scoop 56 causes the milk near the outlet 16 to drop lower than the lowest point of the bottom section 14, which is shown as the lower end 50 of the body portion 46, which leads to the milk beneficially pooling in the area of scoop 56. This configuration allows the milk in the outlet 16 to be lower than the actual bottom (e.g., lower end 50) of the milking claw 10, thereby allowing adequate room for a vacuum to exist above the milk in the milk collecting chamber 20 before it exits through the outlet 16. In one configuration, the opening into the outlet 16 is approximately 0.35 to 0.40 inches below the lower end 50 of the bottom section 14. Preferably, the outlet 16 drops below the lower end 50 of the bottom section 14 an amount that is greater than the size of the outlet diameter 57 of the outlet 16, which for milking claw 10 is approximately 0.875 inches (⅞ inch).

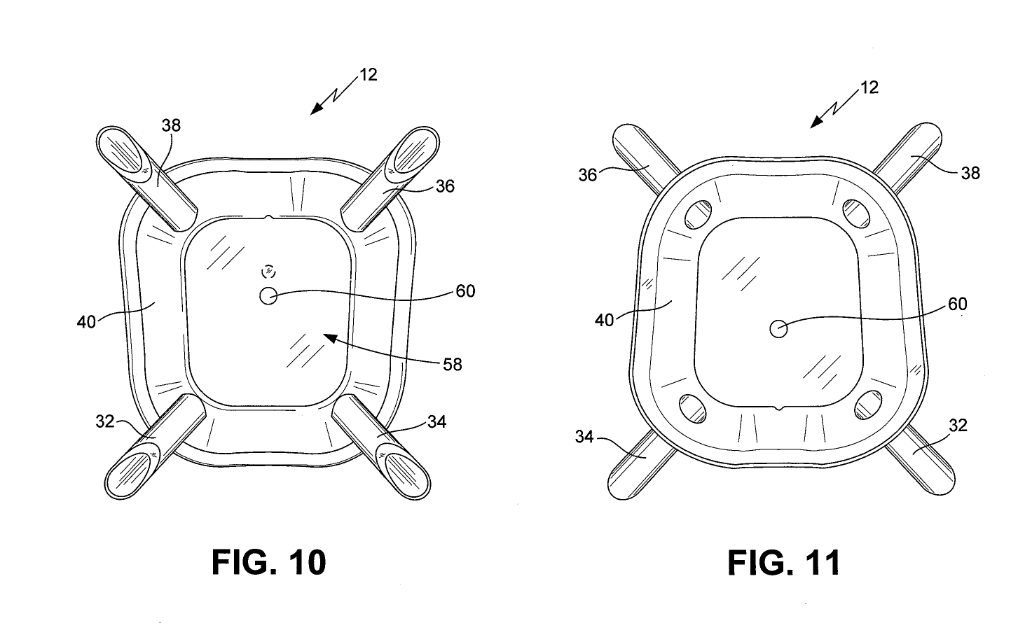

To further increase the transition area 54, the position of the mounting stem 28 in bottom section 14, through which the bolt 27 passes to connect to the pressure manifold/connecting assembly 18 on the upper surface 58 of the upper section 12 by way of an aperture 60 (best shown in FIGS. 10-11, 14 and 16) in upper section 12, is selected so as to be off center, as best shown in FIGS. 7-9, thereby giving more area for a larger scoop 56 of the transition area 54. As best shown in FIG. 8, the center line 62 of the mounting stem 28 (also referred to as a bolt conduit) is set back from the center line 64 of the bottom section 14 an offset amount 66. For the same size of mounting stem 28, which should be as small as possible, the offset amount 66 moves the mounting stem 28 away from the front end 68 of the bottom section 14 towards the back end 70 thereof. As best shown in FIG. 9, because the mounting stem 28 is moved away from the front end 68 the scoop length, shown as 72, of the scoop 56 is increased, which increases the size of transition area 54. Preferably, the mounting stem 28 is moved away from the front end 68 towards the back end 70, increasing the offset amount 66 and scoop length 72, as much as possible to provide as much transition area 54 as possible. In a preferred embodiment, the scoop length 72 is at greater than the diameter 57 (as shown in FIG. 1) of the outlet 76. In one embodiment, the length 57 of scoop 56 is approximately 50% longer than the diameter 57 of the outlet 16. The increased transition area 54 provides benefits for milking claw 10 and the entire milking system, namely it substantially improves the outflow characteristics of the milk to further reduce the likelihood of flooding and unstable vacuum (e.g., in addition to what is achieved due to the increased capacity from the generally rectangular configuration of the milking claw 10) by providing better separation between the milk in the milk collecting chamber 20 and the negative air pressure therein. A likely limitation on how far the mounting stem 28 can be moved toward back end 70, and therefore limiting the offset amount 66 and resulting scoop length 72, is the need to clamp the top section 12 and bottom section 14 together. As can be appreciated by those skilled in the art, too much of an offset amount 66 could prevent the top section 12 from fully clamping to the bottom section 14. In addition, the movement of the mounting stem 28 off center is likely to increase the cost of manufacturing the milking claw 10 of the present invention.

The configuration of the transition area 54 and the addition of the scoop 56 thereto allows the milk to move out of the milk collecting chamber 20 faster, by preventing the milk backing up at the outlet 16, so as to prevent flooding of the chamber 20 and maintain vacuum on top of the outlet 16 and provide for smoother vacuum, which improves milk production from the animal and prevents harm to the teats thereof. The size and configuration of the scoop 56, the size of the opening into and the dropping down (outlet angle 55) of the outlet 16 will stabilize the vacuum and prevent the liners from falling off the teats.

Additional volume for the milk collecting chamber 20 formed by the combination of the top section 12 and bottom section 14 is achieved by using a “V” rectangular shape instead of the traditional round shape of the prior art milking claws. As shown in the figures, the shape of the body portion 46 the bottom section 14 is particularly configured with downward sloping sidewalls 74, as best shown in FIGS. 1-4, from the upper end 48 to the lower end 50 thereof so as to be ergonomically held in a dairy worker's hand while he or she is securing the hanger lug 30 to the hanger and/or attaching the liners to the teats of the animal. The shape of the top section 12 and the bottom section 14 of the milking claw 10 of the present invention provide both the desired increased volume and the ergonomic configuration that is desirable for use of the milking claw 10. As set forth in the Background, prior art milking claws are generally limited to about 300 cc in volume based on size and weight limitations. In contrast, the milk collecting chamber 20 of the milking claw of the present invention is able to be formed in a size ranging from approximately 350 cc to approximately 500 cc, providing a substantial increase in volume that provides the desired operating characteristics that benefits the milking system. In a preferred embodiment of the milking claw 10, the bottom section 14 includes a rubber or rubber like bumper 76, best shown in FIGS. below portion of the milking claw 10 that will typically be positioned in the palm of the user's hand to provide increased ergonomics and to protect the milking claw 10 when it is placed on a surface. A cavity holds the rubber bumper 76, which reduces plastic and the weight associated therewith.

In summary the present invention provides a milking claw 10 generally comprising a top section 12 and a bottom section 14 where: (1) The shape of these components are of a generally rectangular “V” shape for better for ergonomics rather than the round shape used in prior art milking claws; (2) the combined sections 12/14 provide an internal volume of the milk collecting chamber 20 that has a capacity of between 350 cc to 500 cc; (3) the end of the outlet 16 drops an amount that is greater than the outlet diameter 57 from the lower end 50 of the bottom section 14; (4) the outlet 16 has a scoop 56 with a scoop length 72 that is longer than the diameter 57 of the outlet 16; (5) The mounting stem 28 is moved off center to allow more room for the scoop 56 so as to provide a greater transition area 54; (6) the lower end 44 of the top section 12 has a matching shape to the upper end 48 of the bottom section 14; (7) the overall height of the top section 12 is no less than about 0.6 inches to allow for enough room for the installation of the milk inlets 32/34/36/38, but not longer than about 1.0 inch so as to prevent additional and unnecessary height that could interfere with the placement of the milking claw 10 under the animal; and (8) the outlet 16 is angled downwards between about five to twelve degrees in relation to the a plane through the upper end 48 of the bottom section 14 of the milking claw 10.

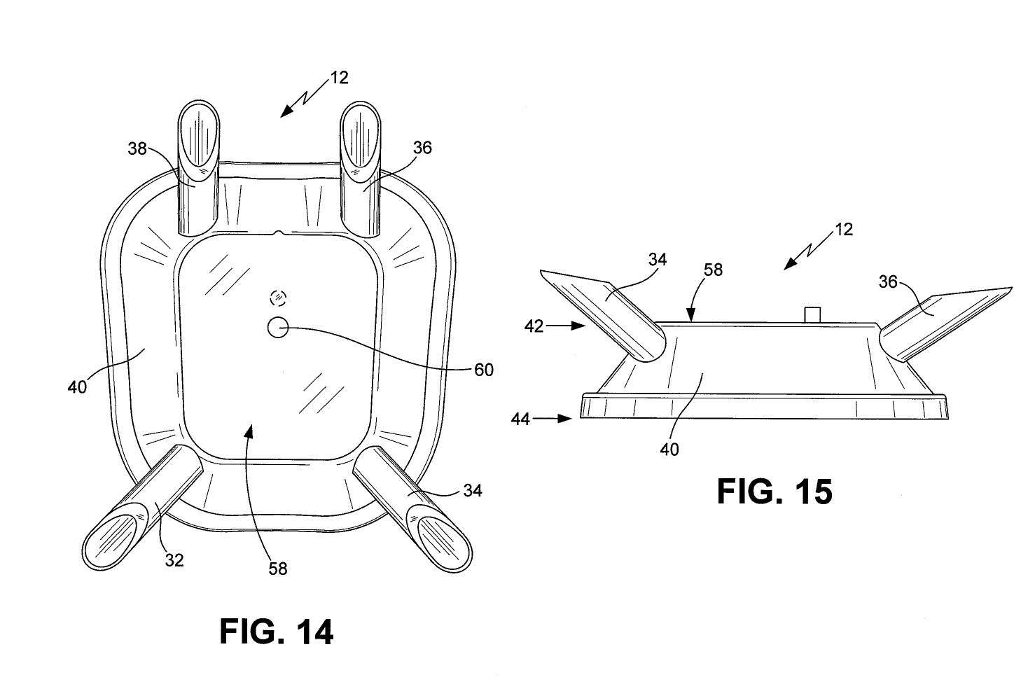

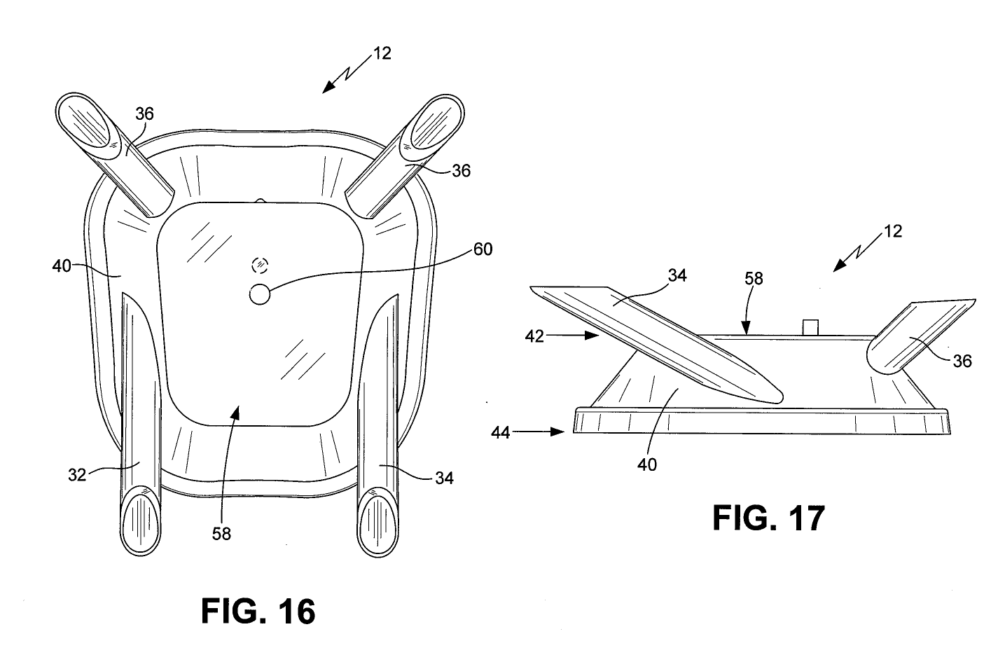

Illustrations of the three different top sections 12 for milking claw 10 of the present invention. The difference between each is the placement and location of the four milk inlets 32/34/36/38. As set forth above, in FIGS. 10-13 the top section 12 is that which is shown in use on the bottom section 14 of the milking claw 10 of FIGS. 1-6. FIGS. 14-15 shows a second embodiment for the top section 12. The placement of the milk inlets 32/34/36/38 in this embodiment has unique characteristics when compared to the top section 12 which is shown in FIGS. 10-13. Likewise, the placement of the milk inlets 32/34/36/38 shown in the third embodiment of top section 12 of FIGS. 16-17 has unique characteristics when compared to the top sections shown in the two embodiment of FIGS. 10-16. As will be readily appreciated by those skilled in the art, the top section 12 is an intricate part of the overall volume of the combined sections 12/14 of milking claw 10. The top section 12 cannot get too tall or it will add undesirable height to the combined parts, resulting in a milking claw 10 that is difficult to place under the animal. Top section 12 is designed with the limitation that the inlets 32/34/36/38 must be placed thereon. The milk inlets 32/34/36/38 typically have an outside diameter of approximately 0.5″. The height of top section 12, however, must be at least 0.6″ tall, which is dictated by the angle of which the milk inlets 32/34/36/38 must be cut to in order to maintain the correct spacing of the parallel inlets. The illustrations of FIGS. 10-17 show this miterd angle in the milk inlets 32/34/36/38 as they enter the top section 12 utilizes most of the height 53 of the top section 12.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. A high capacity milking claw, comprising:
a top section having a body portion with an upper end and a lower end, said body portion defining an upper surface at said upper end thereof;
a bottom section having a body portion with an upper end, a lower end, a front end, a back end and a plurality of sidewalls, said lower end of said top section cooperatively sized with said upper end of said bottom section such that said top section is received on said bottom section to define a milk collecting chamber therebetween;
an outlet attached to or integral with said bottom section so as to be hydraulically connected to said milk collecting chamber to allow milk to flow from said milk collecting chamber, said outlet angled downward from said bottom section an outlet angle;
a pressure manifold/connecting assembly connected to said upper surface of said top section, said pressure manifold/connecting assembly having one or more pulse nozzles, one or more pressure connection conduits and a connecting nut, said pressure manifold/connecting assembly configured to flow milk into said milk collecting chamber;
a mounting stem extending upward from said bottom end of said bottom section towards said top section, said mounting stem having a center line in spaced apart relation, in an offset amount, to a center line of said bottom section in a direction away from said front end of said bottom section towards said back end of said bottom section;
a bolt extending through said mounting stem to connect to said connecting nut so as to clamp said top section to said bottom section; and
a transition area in said bottom section adjacent to said outlet, said transition area comprising a scoop having a scoop length sized and configured to improve the outflow characteristics of milk exiting the milk collecting chamber.

2. The milking claw of claim 1, wherein said milk collecting chamber is sized between approximately 350 cc to approximately 500 cc.

3. The milking claw of claim 1, wherein said sidewalls of said body portion of said bottom section angle generally inward from said top end to said lower end thereof to define a generally rectangular V-shaped configuration for said bottom section.

4. The milking claw of claim 1, wherein said scoop length is longer than an outlet diameter of said outlet.

5. The milking claw of claim 1, wherein said scoop extends between a sidewall of said bottom section and said mounting stem.

6. The milking claw of claim 5, wherein said scoop length is longer than an outlet diameter of said outlet.

7. The milking claw of claim 1, wherein said top section has a height between said upper end and said lower end thereof between approximately 0.6 inches and 1.0 inches.

8. The milking claw of claim 1, wherein said outlet angle of said outlet is between approximately five degrees and twelve degrees relative to a horizontal plane through said upper end of said bottom section.

9. The milking claw of claim 1, wherein said sidewalls of said body portion of said bottom section angle generally inward from said top end to said lower end thereof to define a generally rectangular V-shaped configuration for said bottom section, said milk collecting chamber is sized between approximately 350 cc to approximately 500 cc and said scoop extends between a sidewall of said bottom section and said mounting stem.

10. The milking claw of claim 9, wherein said top section has a height between said upper end and said lower end thereof between approximately 0.6 inches and 1.0 inches.

11. The milking claw of claim 9, wherein said outlet angle of said outlet is between approximately five degrees and twelve degrees relative to said upper end of said bottom section.

12. A top section for a high capacity milking claw, comprising:
a body portion with an upper end and a lower end, said body portion defining an upper surface at said upper end thereof, said lower end cooperatively sized and configured with an upper end of a bottom section so as to engage said bottom section and define a milk collecting chamber between said top section and said bottom section; and
an aperture in said upper surface, said aperture aligned with a mounting stem in said bottom section so as to receive a bolt through said mounting stem that connects with a connecting nut to secure said body portion of said top section to said upper end of said bottom section, said mounting stem having a center line in spaced apart relation, in an offset amount, to a center line of said bottom section in a direction away from said front end of said bottom section towards said back end of said bottom section.

13. The top section of claim 12, wherein said top section has a height between said upper end and said lower end thereof between approximately 0.6 inches and 1.0 inches.

14. The top section of claim 12 further comprising a pressure manifold/connecting assembly connected to said upper surface of said top section, said pressure manifold/connecting assembly having one or more pulse nozzles, one or more pressure connection conduits and a connecting nut, said pressure manifold/connecting assembly configured to flow milk into said milk collecting chamber.

15. A bottom section for a high capacity milking claw, comprising:
a body portion with an upper end, a lower end, a front end, a back end and a plurality of sidewalls substantially extending between said upper end and said lower end, said upper end of said body portion cooperatively sized with a lower end of a top section such that said top section is received on said bottom section to define a milk collecting chamber therebetween;
an outlet attached to or integral with said bottom section so as to be hydraulically connected to said milk collecting chamber to allow milk to flow from said milk collecting chamber, said outlet angled downward from said bottom section an outlet angle;
a mounting stem extending upward from said bottom end of said bottom section towards said top section, said mounting stem sized and configured to receive a bolt therethrough to connect to a connecting nut so as to clamp said top section to said bottom section, said mounting stem having a center line in spaced apart relation, in an offset amount, to a center line of said bottom section in a direction away from said front end of said bottom section towards said back end of said bottom section; and
a transition area in said bottom section adjacent to said outlet, said transition area comprising a scoop having a scoop length.

16. The bottom section of claim 15, wherein said sidewalls of said body portion of said bottom section angle generally inward from said top end to said lower end thereof to define a generally rectangular V-shaped configuration for said bottom section, said milk collecting chamber being sized between approximately 350 cc to approximately 500 cc.

17. The bottom section of claim 16 wherein said scoop extends between a sidewall of said bottom section and said mounting stem.

18. The bottom section of claim 15, wherein said outlet angle of said outlet is between approximately five degrees and twelve degrees relative to said upper end of said bottom section.

19. The bottom section of claim 15, wherein said scoop extends between a sidewall of said bottom section and said mounting stem.

20. The bottom section of claim 15, wherein said scoop length is longer than an outlet diameter of said outlet.
